(19) United States
(12) Patent Application Publication
(10) Pub. No.: US 2025/0036444 A1
(43) Pub. Date: Jan. 30, 2025

(54) DISTRIBUTED SWITCH MANAGEMENT IN A VIRTUALIZED COMPUTING SYSTEM

(71) Applicant: VMware, Inc., Palo Alto, CA (US)

(72) Inventors: Kejia CUI, Beijing (CN); Lele ZHANG, Beijing (CN); Honggang LIU, Beijing (CN); Qi WU, Beijing (CN); Donghai HAN, Beijing (CN)

(21) Appl. No.: 18/451,532

(22) Filed: Aug. 17, 2023

(30) Foreign Application Priority Data
Jul. 24, 2023 (WO) PCT/CN2023/108821

(51) Int. Cl. G06F 9/455

(52) U.S. Cl. CPC G06F 9/45558; G06F 2009/45595

(57) ABSTRACT

An example computing system includes software, executing on a hardware platform, configured to manage hypervisors and a distributed switch executing in a host cluster, the software including a control plane of the distributed switch, the hypervisors providing a data plane of the distributed switch, the host cluster including hosts, the distributed switch supporting features; a host membership manager of the software configured to track which of the hosts in the host cluster are members of a group that executes the distributed switch; a feature manager of the software configured to track which of the features of the distributed switch are enabled; and a compatibility checker of the software configured with compatibility data that relates the features of the distributed switch with hypervisor version requirements.

### CROSS-REFERENCE

This application is based upon and claims the benefit of priority from International Patent Application No. PCT/CN2023/108821, filed on Jul. 24, 2023, the entire contents of which are incorporated herein by reference.

### BACKGROUND

A software-defined datacenter (SDDC) may include a server virtualization layer having clusters of physical servers that are virtualized and managed by virtualization management servers. Each physical server, referred to herein as a host, includes a virtualization layer including a hypervisor that provides a software abstraction of a physical server resources including central processing units (CPUs), random access memory (RAM), storage, network interface card (NIC), etc.) for the VMs. A virtualization management server allows for creating host clusters, adding and removing hosts from host clusters, deploying, moving, and removing VMs on the hosts, deploying, and configuring networking and provisioning storage, and the like. The virtualization management server manages the server virtualization layer of the SDDC and treats host clusters as pools of compute capacity for use by the VMs and applications that run thereon.

The virtualization management server can deploy a distributed switch as software executing in the host cluster. The distributed switch provides a centralized interface to manage networking among VMs on host clusters in a data center. The virtualization management server is the point for managing the control plane of the distributed switch. Data plane functionality of the distributed switch is implemented using software installed to the host hypervisors.

A distributed switch as software can have multiple versions. A distributed switch deployed in a host cluster can be upgraded from one version to another version. The version of a distributed switch depends on the version of the virtualization management server and the version of the host hypervisors and cannot be upgraded independent of these other software components. For example, a distributed switch cannot be upgraded to a version that is unsupported by the current version of the virtualization management server. A host cannot join a distributed switch if the current version of the hypervisor does not support the version of the distributed switch.

Upgrading a distributed switch can be user-driver (e.g., the user desires new feature(s)) or driven by software dependency (e.g., a version of the virtualization management server no longer supports the current version of a distributed switch). In either case, upgrading a distributed switch deployed on a host cluster is nontrivial, requiring the user to understand the versions of the software on which the distributed switch depends and the currently deployed versions of such software in the data center. Mistakes can lead to loss of connectivity and downtime for the VMs using the distributed switch for network access.

### SUMMARY

In an embodiment, a computing system comprises a hardware platform and software executing on the hardware platform. The software configured to manage hypervisors and a distributed switch executing in a host cluster. The software including a control plane of the distributed switch. The hypervisors providing a data plane of the distributed switch. The host cluster including hosts and the distributed switch supporting features. A host membership manager of the software configured to track which of the hosts in the host cluster are members of a group that executes the distributed switch. A feature manager of the software configured to track which of the features of the distributed switch are enabled. A compatibility checker of the software configured with compatibility data that relates the features of the distributed switch with hypervisor version requirements. The host membership manager and the feature manager cooperate with the compatibility checker to determine whether a first host can be added to the group and whether a first feature of the distributed switch can be enabled.

A method of managing a distributed switch executing in a host cluster includes receiving, at a virtualization management server that manages hypervisors executing in hosts of the host cluster, a request to add a first host to a group of the hosts that executes the distributed switch. The method includes determining enabled features of features supported by the distributed switch. The method includes determining a hypervisor version requirement in response to the enabled features. The method includes adding the first host to the group in response to a version of a hypervisor executing on the first host satisfying the hypervisor version requirement.

A method of managing a distributed switch executing in a host cluster includes receiving, at a virtualization management server that manages hypervisors executing hosts of the host cluster, a request to enable a first feature of a set of features of the distributed switch, the virtualization management server managing hypervisors executing in hosts of the host cluster. The method includes determining a group of the hosts that executes the distributed switch. The method includes determining a hypervisor version requirement for the first feature. The method includes enabling the first feature of the distributed switch in response to each host in the group of hosts executing a version of a hypervisor that satisfies the hypervisor version requirement.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram depicting an example of virtualized infrastructure that supports the techniques described herein.

FIG. 2 is a block diagram depicting deployment of a distributed switch according to embodiments.

FIG. 3 is a block diagram depicting a distributed switch manager according to embodiments.

FIG. 4 is a flow diagram depicting a method of adding a host to execute a distributed switch according to embodiments.

FIG. 5 is a flow diagram depicting a method of enabling a feature of a distributed switch according to embodiments.

### DETAILED DESCRIPTION

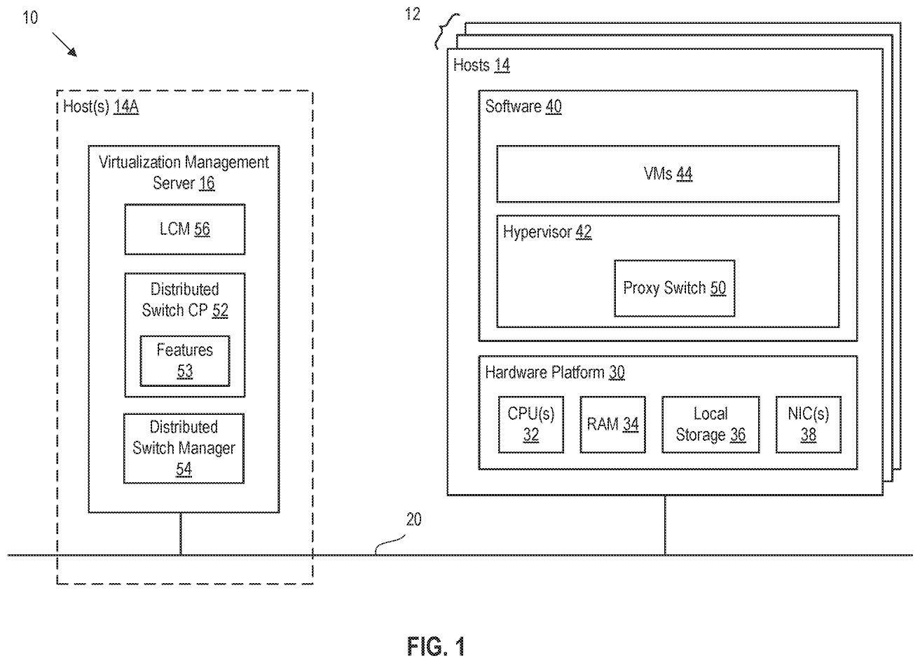

FIG. 1 is a block diagram depicting an example of virtualized infrastructure 10 that supports the techniques described herein. In general, virtualized infrastructure comprises computers (hosts) having hardware (e.g., processor, memory, storage, network) and virtualization software executing on the hardware. In the example, virtualized infrastructure 10 includes a cluster of hosts 14 (“host cluster 12”) that may be constructed on hardware platforms such as an x86 or ARM architecture platforms. For purposes of clarity, only one host cluster 12 is shown. However, virtualized infrastructure 10 can include many of such host clusters 12. As shown, a hardware platform 30 of each host 14 includes conventional components of a computing device, such as one or more central processing units (CPUs) 32, system memory (e.g., random access memory (RAM) 34), one or more network interface controllers (NICs) 38, and optionally local storage 36.

CPUs 32 are configured to execute instructions, for example, executable instructions that perform one or more operations described herein, which may be stored in RAM 34. The system memory is connected to a memory controller in CPU 32 or on hardware platform 30 and is typically volatile memory (e.g., RAM 34). Storage (e.g., local storage 36) is connected to a peripheral interface in CPU 32 or on hardware platform 30 (either directly or through another interface, such as NICs 38). Storage is persistent (nonvolatile). As used herein, the term memory (as in system memory) is distinct from the term storage (as in local storage or shared storage). NICs 38 enable host 14 to communicate with other devices through a physical network 20. Physical network 20 enables communication between hosts 14 and between other components and hosts 14.

Software 40 of each host 14 provides a virtualization layer, referred to herein as a hypervisor 42, which directly executes on hardware platform 30. In an embodiment, there is no intervening software, such as a host operating system (OS), between hypervisor 42 and hardware platform 30. Thus, hypervisor 42 is a Type-1 hypervisor (also known as a “bare-metal” hypervisor). As a result, the virtualization layer in host cluster 12 (collectively hypervisors 42) is a bare-metal virtualization layer executing directly on host hardware platforms. Hypervisor 42 abstracts processor, memory, storage, and network resources of hardware platform 30 to provide a virtual machine execution space within which multiple virtual machines (VM) 44 may be concurrently instantiated and executed.

A virtualization management server 16 is a non-virtualized or virtual server that manages host cluster 12 and the virtualization layer therein. Virtualization management server 16 installs agent(s) in hypervisor 42 to add a host 14 as a managed entity Virtualization manager 16 logically groups hosts 14 into host cluster 12 to provide cluster-level functions to hosts 14, such as VM migration between hosts 14 (e.g., for load balancing), distributed power management, dynamic VM placement according to affinity and anti-affinity rules, and high-availability. The number of hosts 14 in host cluster 12 may be one or many. Virtualization management server 16 can manage more than one host cluster 12. Virtualized infrastructure 10 can include more than one virtualization management server 16, each managing one or more host clusters 12.

Virtualization management server 16 includes a lifecycle manager (LCM) 56, a distributed switch control plane (CP) 52, and a distributed switch manager 54. Distributed switch CP 52 comprises a control plane of a distributed switch deployed in virtualized infrastructure 10. A distributed switch comprises a control plane and a data plane. The control plane executes in virtualization management server 16 (distributed switch CP 52). The data plane executes in a group of hosts 14 each of which is a member of the distributed switch. In each member host 14, the data plane includes a proxy switch 50 executing in hypervisor 42. Distributed switch CP 52 aggregates proxy switches 50 across member hosts 14 to implement the distributed switch. The distributed switch provides network switching among VMs 44 in the member hosts and between VMs 44 and other entities accessible on network 20. The distributed switch can implement various network devices, such as switches, routers, and the like.

In embodiments, the distributed switch does not expose a version to the user (e.g., the version information is internal to the distributed switch software). Rather, distributed switch CP 52 exposes a set of features 53 to the user. LCM 56 is configured to upgrade virtualization management server 16, e.g., from one version to another version. An upgrade of the version of virtualization management server 16 can update features 53, e.g., add new features, modify existing features, remove deprecated features, mark existing features as deprecated, etc.

With traditional versioned distributed switch software, there is a dependency on the version of the virtualization management server. For example, previously a given version of the virtualization management server can support distributed switches having a current version and the last two versions (e.g., version 8.0 of a virtualization management server can support versions 8.0, 7.0, and 6.0 of a distributed switch, but not version 5.0 of a distributed switch). In that example, a user having version 5.0 of the distributed switch would be forced to upgrade the distributed switch when upgrading the virtualization management server to 8.0. The user would be required to upgrade the virtual switch even if all of the features currently being used are supported by the newest version and the user does not desire to use any new features.

In the embodiments, the distributed switch is “version-less” to the user. An upgrade of virtualization management server 16 does not force an upgrade of the virtual switch due only to the fact of version dependency. If all enabled features of the distributed switch are supported after the upgrade of virtualization management server 16 (e.g., the user is not using previously deprecated features), then no forced upgrade of the distributed switch is required. If an upgrade of virtualization management server 16 adds new features 53, the user can add such new features as needed or desired. Distributed switch manager 54 implements workflows for enabling new features of distributed switch and for adding new hosts as members for the distributed switch.

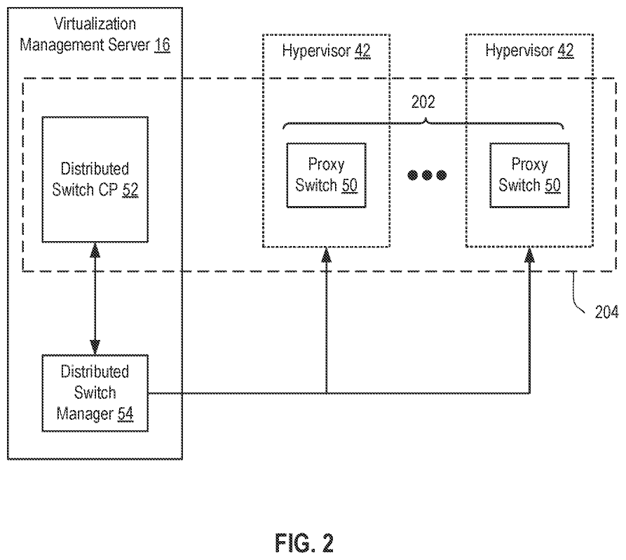

FIG. 2 is a block diagram depicting deployment of a distributed switch according to embodiments. A distributed switch 204 includes distributed switch CP 52, executing in virtualization management server 16, and proxy switches 50, executing in hypervisors 42 of hosts 14 (hosts 14 shown in FIG. 1). Proxy switches 50 comprise a data plane 202 of distributed switch 204 and distributed switch CP 52 comprises a control plane of distributed switch 204. Distributed switch manager 54 cooperates with distributed switch CP 52 as described herein. Distributed switch manager 54 can also cooperate with hypervisors 42 as described herein.

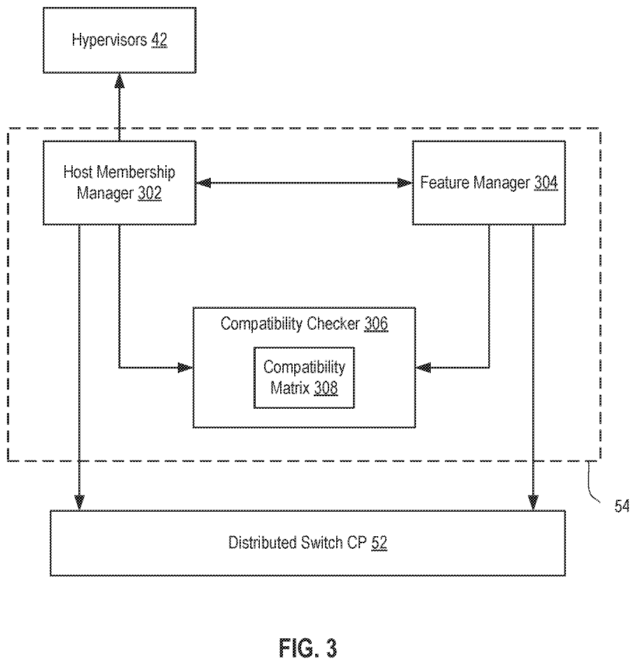

FIG. 3 is a block diagram depicting distributed switch manager 54 according to embodiments. Distributed switch manager 54 includes a host membership manager 302, a feature manager 304, and a compatibility checker 306. Compatibility checker 306 is configured with a compatibility matrix 308. Host membership manager 302 and feature manager 304 can communicate with distributed switch CP 52. In embodiments, host membership manager 302 can communicate with hypervisors 42.

Host membership manager 302 handles requests from the user to add/remove hosts to/from distributed switch 204. Host membership manager 302 tracks host membership of distributed switch 204. While a single distributed switch 204 is described in the example, host membership manager 302 can track host membership for multiple distributed switches managed by virtualization management server 16. Feature manager 304 handles requests from the user to enable/disable features 53 of distributed switch 204. Feature manager 304 also tracks which features 53 are enabled (“enabled features”) and which features 53 are disabled (“disabled features”). While a single distributed switch 204 is described in the example, feature manager 304 can track enabled/disabled features for multiple distributed switches managed by virtualization management server 16. A user can interact with host membership manager 302 and feature manager 304 directly (e.g., through an application programming interface (API)) or indirectly through another interfaces (e.g., API) of virtualization management server 16. In examples described herein, a user submits requests to distributed switch manager 54 either directly or indirectly through software of virtualization management server 16. In other examples, software can submit requests to distributed switch manager 54, directly or indirectly, on behalf of a user (e.g., through automation).

Compatibility checker 306 is configured with compatibility matrix 308. Compatibility matrix 308 stores relations between features 53 and hypervisor version requirements. A hypervisor version requirement is a required version of hypervisor 42 to support a corresponding feature. Compatibility matrix 308 can be updated through upgrades of virtualization management server 16 (e.g., as features are added/removed). Host membership manager 302 and feature manager 304 communicate with compatibility checker 306 to obtain hypervisor version requirements during the workflows to add a host and enable a feature.

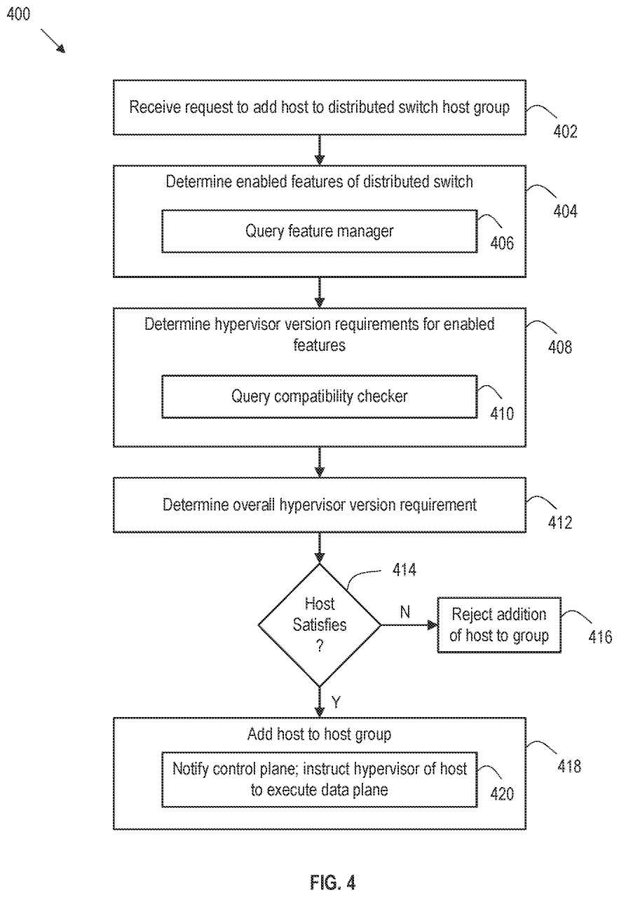

FIG. 4 is a flow diagram depicting a method 400 of adding a host to execute a distributed switch according to embodiments. Method 400 begins at step 402, where host membership manager 302 receives a request to add a host to the host group for distributed switch 204. At step 404, host membership manager 302 determines the enabled features of distributed switch 204. For example, at step 406, host membership manager 302 queries feature manager 304 for the set of enabled features of distributed switch 204. Feature manager 304 tracks the enabled features and returns the set of enabled features to host membership manager 302.

At step 408, host membership manager 302 determines hypervisor version requirements for the enabled features. For example, host membership manager 302 queries compatibility checker 306 (410). Compatibility checker 306 checks compatibility matrix 308 for each enabled feature and obtains the corresponding hypervisor version requirement. Compatibility checker 306 returns a set of hypervisor version requirements to host membership manager 302. At step 412, host membership manager 302 determines an overall hypervisor version requirement for distributed switch. The overall hypervisor version requirement is the strictest requirement in the set of hypervisor version requirements returned by compatibility checker 306. For example, if hypervisor version requirements of 8.0, 7.0, and 6.0 are returned, the overall hypervisor version requirement is 8.0. In another example, the version requirement of each feature can be a range. For example, if a new feature is introduced in version 7.0, then its requirement can be any version greater than or equal to 7.0. In another example, if a feature is deprecated in version 8.0, then its requirement would be any version less than or equal to 8.0. In another example, if that feature was introduced in 7.0 and deprecated in 8.0, then its requirement would be between 7.0 and 8.0 inclusive. The overall hypervisor version requirement is the intersection of the version requirements of all enabled features and can be a range of versions.

At step 414, host membership manager 302 determines if the host being added satisfies the overall hypervisor version requirement. That is, whether the hypervisor executing in the host being added has a version that is in the range of the hypervisor version requirement. If not, method 400 proceeds to step 416, where host membership manager 302 rejects the addition of the host to the host group. In such case, the hypervisor of the host being added cannot support all features of distributed switch 204 and thus the host cannot be added to the host group. If at step 414 the host being added does satisfy the overall hypervisor version requirement, method 400 proceeds to step 418. At step 418, host membership manager 302 adds the host to the host group for distributed switch 204. For example, at step 420, host membership manager 302 can notify distributed switch CP 52 of the host being added to the host group. In embodiments, host membership manager 302 can instruct hypervisor 42 of the host being added to execute the data plane of distributed switch 204 (e.g., execute proxy switch 50). In other embodiments, host membership manager 302 only notifies distributed switch CP 52, which in turn handles instructing hypervisor 42 of the host being added.

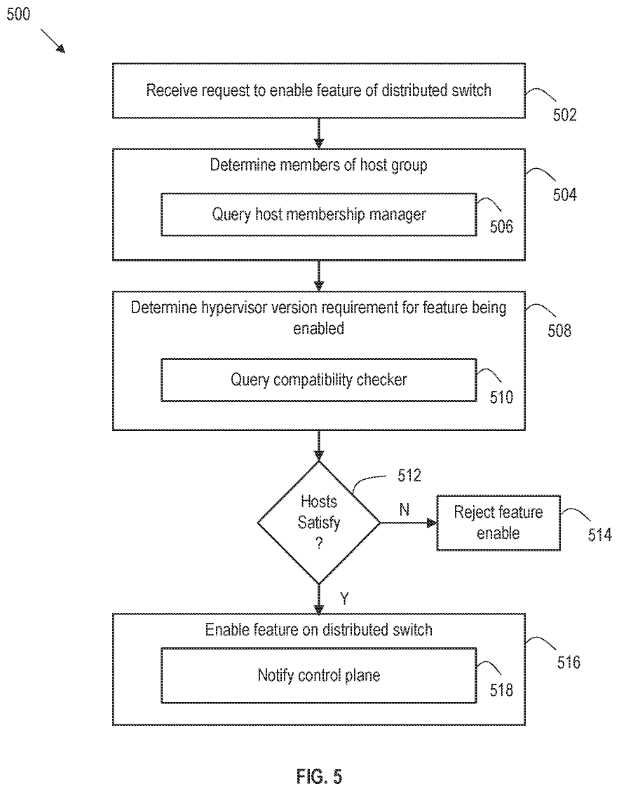

FIG. 5 is a flow diagram depicting a method 500 of enabling a feature of a distributed switch according to embodiments. Method 500 begins at step 502, where feature manager 304 receives a request to enable a feature 53 of distributed switch 204. At step 504, feature manager 304 determines members of the host group executing the data plane of distributed switch 204. For example, at step 506, feature manager 304 queries host membership manager 302 for the host group. Host membership manager 302 tracks the hosts in the host group for distributed switch 204 and returns the host group to feature manager 304.

At step 508, feature manager 304 determines a hypervisor version requirement for the feature being enabled. For example, at step 510, feature manager 304 queries compatibility checker 306. Compatibility checker 306 checks compatibility matrix 308 for the enabled feature and obtains the corresponding hypervisor version requirement. Compatibility checker 306 returns the hypervisor version requirement to feature manager 304. At step 512, feature manager 304 determines if the hosts in the host group satisfy the hypervisor version requirement for the feature being enabled. That is, whether the hypervisors executing in the hosts of the host group each have a version that is in the range of the hypervisor version requirement. If not, method 500 proceeds to step 514, where the feature manager 304 rejects the request to enable the feature. In such case, there is at least one host having a hypervisor with a version that does not support the feature being enabled. If at step 512 the hosts in the host group satisfy the hypervisor version requirement, method 500 proceeds to step 516.

At step 516, feature manager 304 enables the feature on distributed switch 204. For example, at step 518, feature manager 304 notifies distributed switch CP 52 to enable the requested feature.

Host membership manager 302 can remove hosts from the host group as requested without checking for an overall hypervisor version requirement. Likewise, feature manager 304 can disable features of distributed switch 204 without checking for hypervisor version requirements. In both cases, distributed switch manager 54 communicates with distributed switch CP 52 to remove host(s) and/or disable feature(s) of the distributed switch. Distributed switch manager 54 can optionally communicate with host(s) being removed to notify the hypervisor(s) thereof. Alternatively, distributed switch CP 52 is configured to communicate with the hypervisor(s) of the host(s) being removed.

Distributed switch management in a virtualized computing system has been described. In embodiments, a distributed switch executing as software across a virtualization management server and a plurality of host hypervisors is version-less. Upgrade of the distributed switch is decoupled from the version of the virtualization management server. Upgrade of the virtualization management server does not force an upgrade of the distributed switch by virtue of version comparison between the virtualization management server and the distributed switch. Rather, a user can enable/disable features of the distributed switch, and can add/remove hosts from the distributed switch, as desired (decoupled from the upgrade of the virtualization management server).

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A computing system, comprising:
a hardware platform;
software, executing on the hardware platform, configured to manage hypervisors and a distributed switch executing in a host cluster, the software including a control plane of the distributed switch, the hypervisors providing a data plane of the distributed switch, the host cluster including hosts, the distributed switch supporting features;
a host membership manager of the software configured to track which of the hosts in the host cluster are members of a group that executes the distributed switch;
a feature manager of the software configured to track which of the features of the distributed switch are enabled; and
a compatibility checker of the software configured with compatibility data that relates the features of the distributed switch with hypervisor version requirements;
wherein the host membership manager and the feature manager cooperate with the compatibility checker to determine whether a first host can be added to the group and whether a first feature of the distributed switch can be enabled.

2. The computing system of claim 1, wherein the host membership manager is configured to:
receive a request to add the first host to the group executing the distributed switch;
query the feature manager for enabled features of the distributed switch;
query the compatibility checker to determine a hypervisor version requirement in response to the enabled features; and
add the first host to the group in response to a version of a hypervisor executing on the first host satisfying the hypervisor version requirement.

3. The computing system of claim 2, wherein the host membership manager is configured to add the first host to the group by notifying the control plane.

4. The computing system of claim 3, wherein the host membership manager is configured to add the first host to the group by instructing the hypervisor of the first host to execute a proxy switch of the data plane.

5. The computing system of claim 2, wherein the hypervisor version requirement is an overall hypervisor version requirement formed from a plurality of hypervisor version requirements associated with the enabled features.

6. The computing system of claim 1, wherein the feature manager is configured to:
receive a request to enable the first feature of the distributed switch;
query the host membership manager for the group of hosts executing the distributed switch;
query the compatibility checker to determine a hypervisor version requirement for the first feature; and
enable the first feature in response to each host in the group executing a version of a hypervisor that satisfies the hypervisor version requirement.

7. The computing system of claim 1, wherein the software executes in a virtualization management server connected to a network, and wherein the distributed switch provides an interface between virtual machines (VMs) executing on the hosts in the group and the network.

8. A method of managing a distributed switch executing in a host cluster, comprising:
receiving, at a virtualization management server that manages hypervisors executing in hosts of the host cluster, a request to add a first host to a group of the hosts that executes the distributed switch;
determining enabled features of features supported by the distributed switch;
determining a hypervisor version requirement in response to the enabled features; and
adding the first host to the group in response to a version of a hypervisor executing on the first host satisfying the hypervisor version requirement.

9. The method of claim 8, wherein the virtualization management server includes a host membership manager that tracks which of the hosts in the host cluster are members of the group that executes the distributed switch and a feature manager that tracks which of the features of the distributed switch are enabled, and wherein the step of determining the enabled features comprises:
querying, by the host membership manager, the feature manager for the enabled features of the distributed switch.

10. The method of claim 9, wherein the virtualization management server includes a compatibility checker configured with compatibility data that relates the features of the distributed switch with hypervisor version requirements, and wherein the step of determining the hypervisor version requirement comprises:
querying, by the host membership manager, the compatibility checker to determine the hypervisor version requirement in response to the enabled features.

11. The method of claim 10, wherein the virtualization management server executes a control plane of the distributed switch, wherein the group of hosts execute a data plane of the distributed switch, and wherein the step of adding comprises the host membership manager adding the first host to the group by notifying the control plane.

12. The method of claim 11, wherein the step of adding comprises instructing, by the host membership manager, the hypervisor of the first host to execute a proxy switch of the data plane.

13. The method of claim 8, wherein the hypervisor version requirement is an overall hypervisor version requirement formed from a plurality of hypervisor version requirements associated with the enabled features.

14. The method of claim 8, wherein the virtualization management server is connected to a network and wherein the distributed switch provides an interface between virtual machines (VMs) executing on the hosts in the group and the network.

15. A method of managing a distributed switch executing in a host cluster, comprising:
receiving, at a virtualization management server that manages hypervisors executing hosts of the host cluster, a request to enable a first feature of a set of features of the distributed switch, the virtualization management server managing hypervisors executing in hosts of the host cluster;
determining a group of the hosts that executes the distributed switch;
determining a hypervisor version requirement for the first feature; and
enabling the first feature of the distributed switch in response to each host in the group of hosts executing a version of a hypervisor that satisfies the hypervisor version requirement.

16. The method of claim 15, wherein the virtualization management server includes a host membership manager that tracks which of the hosts in the host cluster are members of the group that executes the distributed switch and a feature manager that tracks which of the features of the distributed switch are enabled, and wherein the step of determining the group of the hosts comprises:
querying, by the feature manager, the host membership manager for the group of hosts executing the distributed switch.

17. The method of claim 16, wherein the virtualization management server includes a compatibility checker configured with compatibility data that relates the features of the distributed switch with hypervisor version requirements, and wherein the step of determining the hypervisor version requirement comprises:
querying, by the feature manager, the compatibility checker to determine the hypervisor version requirement for the first feature.

18. The method of claim 17, wherein the virtualization management server executes a control plane of the distributed switch, and wherein the group of hosts execute a data plane of the distributed switch.

19. The method of claim 18, wherein the step of enabling comprises notifying the control plane to enable the first feature of the distributed switch.

20. The method of claim 15, wherein the virtualization management server is connected to a network and wherein the distributed switch provides an interface between virtual machines (VMs) executing on the hosts in the group and the network.
